(19) United States
(12) Patent Application Publication
(10) Pub. No.: US 2026/0307093 A1
(43) Pub. Date: Oct. 8, 2026

(54) FUMIGATION APPARATUS AND METHOD OF FUMIGATION

(71) Applicant: Universal Biosecurity Limited, Nedlands (AU)

(72) Inventors: David MILLER, Nedlands (AU); Ben GILL, Nedlands (AU); Tom PUDDY, Nedlands (AU); Yonglin REN, Nedlands (AU)

(73) Assignee: Universal Biosecurity Limited, Nedlands (AU)

(21) Appl. No.: 19/480,591

(22) PCT Filed: May 2, 2023
(86) PCT No.: PCT/AU2023/050368

§ 371 Date: Oct. 31, 2025

(51) Int. Cl. B05B 12/10; A01M 13/00; B05B 7/16; B05B 12/00; B05B 12/08

(52) U.S. Cl. CPC B05B 12/10; A01M 13/00; B05B 7/1626; B05B 12/006; B05B 12/085

(57) ABSTRACT

According to one example of the present disclosure a fumigation apparatus comprises a mixing chamber having a first inlet and a second inlet. A gas regulator, pump or compressor directs a stream of non-flammable gas along a first channel from a non-flammable gas source through or past a heater to the first inlet of the mixing chamber and a chemical agent pump directs a stream of chemical fumigant agent along a second channel from a source of the chemical fumigant agent to a second inlet of the mixing chamber. A temperature sensor measures a temperature of a mixed stream of hot gas and chemical fumigant agent at an outlet of the apparatus. A controller controls the gas regulator, pump or compressor and/or the chemical agent pump based on the temperature measured by the temperature sensor, so as to maintain the stream of hot gas and chemical fumigant agent leaving the fumigation apparatus outlet at or above a predetermined temperature.

### TECHNICAL FIELD

The present disclosure relates to a fumigation apparatus and a method of fumigation.

### BACKGROUND

Fumigants are volatile chemicals or poisonous gases which are typically generated from liquid and/or solid agents. They possess bactericidal, fungicidal, insecticidal and/or nematicidal properties and are used to disinfest or kill and control pests, pathogens and weeds. Fumigation is the art of dispensing and applying gaseous substances into an enclosure especially for the purpose of disinfesting, controlling or eliminating undesirable organisms.

Fumigants are active in the gaseous state and can penetrate into free air space in and around produce and into cracks and crevices in the storage structure and enclosure in toxic concentrations, killing target organisms and their breeding stages. Fumigants are widely used for insect, rodent and fungus control or disinfestation of stored products, food, cut flowers, timber, buildings and soils because they are not only generally effective but also relatively cheap.

Foodstuffs such as fruit and grains are particularly susceptible to infestation by invertebrates. Some economic regions, such as Australia, have a ‘nil tolerance’ for live insects in exports to protect the reputation of their local produce. These regions typically adopt extensive fumigation practices to mitigate infestation risk. Equipment and facilities can also experience infestation and may also be treated by fumigation to control these pests. Similarly, buildings, ship vessels, containers, fruit trees, timber and soil may require treatment by fumigation to control various pathogens and pests.

There are a multitude of chemical agents which can be used as a fumigant for fumigation purposes, including hydrogen cyanide, calcium cyanide, carbon dioxide, sulphur dioxide, carbon tetrachloride, ethylene dichloride, ethyl formate, ethylene bromide, p-dichlorobenzene, 1,3-dichloropropene, chloropicrin, formaldehyde, methyl isocyanate, phosphine, methyl bromide and sulfuryl fluoride. Each of these agents have certain advantages and disadvantages, including hazards from toxicity and flammability.

Methyl bromide and phosphine are two chemical agents commonly used in fumigation control or prevention of invertebrate infestations. Methyl bromide is a broad spectrum pesticide having non-specific toxicity to a wide range of invertebrates. However, methyl bromide can have deleterious effects on humans and other animals if they are exposed to high concentrations. Methyl bromide has a further disadvantage in that it is now widely accepted to be a known and significant ozone depleting substance. Artificial addition of methyl bromide to the atmosphere via fumigation contributes to thinning of the ozone layer, the detrimental effects of which are well known and documented. Nevertheless, methyl bromide remains a preferred fumigant for many quarantine authorities.

Phosphine is often relied on for fumigation of grain and other similar commodities and is effective if used properly. However, due to improper application and excessive reliance, there are increasing reports of phosphine resistance. Some regions, who have almost total reliance on this single fumigant through the value chain, have been placed in a dangerous position with respect to development of phosphine resistance and have required implementation of phosphine resistance monitoring and management programs.

Ethyl formate is an agent having properties that indicate usefulness as a fumigant, particularly in controlling invertebrates. Ethyl formate vapour has been shown to be toxic to insects common to infestation of stored commodities. Ethyl formate is a naturally occurring compound, found in various foods, which rapidly breaks down into harmless and naturally occurring compounds. Despite it being able to be absorbed into the body by inhalation of its vapour and by ingestion, skin and/or eye contact, ethyl formate has relatively low human toxicity. These features indicate suitability for treatment of food commodities.

Ethyl formate is liquid at normal ambient temperatures and has a boiling point of 54° C., however is highly flammable with 2.8% (v/v) or 92 g/m⁻³ of lower explosive limit (LEL). This poses a significant problem in practical use of ethyl formate as a fumigant as it is necessary to avoid conditions that can ignite a flame. Other fumigants useful in control of invertebrates, such as ethylene dichloride and propylene oxide, also have similar flammability concerns with their use as a fumigant.

Fumigation is inherently a hazardous operation since chemical agents used in fumigation are typically toxic to most forms of life, in some cases, including humans. Use of agents that are flammable increases the level of hazard, since in order to apply liquid agents as a fumigant, the agent must be converted from liquid to gas, typically by a vaporiser which requires some application of heat. It is not desirable to apply a liquid agent without vaporisation since levels of non-vaporised agent can pose occupational health and safety concerns and/or cause damage to goods being treated with the agent.

Application of flammable agents as a fumigant thus requires careful operation to mitigate risk of ignition. It is known to mix liquid agent and non-flammable gas in cylinders to form a non-flammable formulation under high pressure. However, the practice of using gas in cylinders has at least the disadvantage of potential carburettor icing phenomenon, particularly in cold or humid environments. This effect can increase application time significantly as the gas cylinder and regulator becomes frozen. Furthermore, if pressurised fumigant agents are used, well trained fumigant operators, appropriately trained in handling of high pressure cylinders, must be employed to apply the fumigant.

It is also known to create a substantially non-flammable fumigant agent at high pressure by combining liquid fumigant with carbon dioxide. Carbon dioxide is provided in sufficient quantity to render the flammable liquid as non-flammable. However, these mixtures have all the limitations associated with use of pressurised canisters, as well as the additional limitations of undesirable degradation or corrosion of some materials by the carbon dioxide, emissions of greenhouse gas and phytotoxicity to fresh fruit and vegetables. These difficulties limits the scope of use of such mixtures.

Existing vaporiser designs can demonstrate variability in heating of the liquid agent, resulting in incomplete or partial vaporisation of the agent. This can result in inefficient and ineffective application of the agent, including non-homogenous distribution of agent throughout a treatment area and/or damage to goods due to settling of unvaporised agent. Known vaporiser designs are also typically limited to a single batch or limited volume of liquid agent in a chamber. The chamber must be refilled with liquid agent before further applications can be undertaken, typically requiring stopping of operation as well as allowing a cooling period between applications. There is therefore a need for improvements in fumigation technology, to expand the range of agents that can be used safely and effectively in fumigation and to mitigate various operational inefficiencies and safety hazards.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

With the above in mind, according to a first aspect of the present disclosure, there is provided a fumigation apparatus comprising: a mixing chamber including a first inlet for receiving a stream of a hot gas, a second inlet for receiving a stream of chemical fumigant agent and a mixing chamber outlet for outputting a mixed stream of hot gas and chemical fumigant agent; a gas regulator, pump or compressor for directing a stream of non-flammable gas along a first channel from a non-flammable gas source to the first inlet of the mixing chamber; a heater for heating the stream of non-flammable gas in the first channel to provide a stream of hot gas to the first inlet of the mixing chamber; a chemical agent pump for directing a stream of chemical fumigant agent along a second channel from a source of the chemical fumigant agent to the second inlet of the mixing chamber; a fumigation apparatus outlet in fluid communication with the mixing chamber outlet for ejecting the mixed stream of hot gas and chemical fumigant agent; a temperature sensor for measuring a temperature of the mixed stream of gas and chemical fumigant agent leaving the fumigation apparatus outlet; and a controller for controlling the gas regulator, pump or compressor and/or the chemical agent pump based on the temperature measured by the temperature sensor, so as to maintain the stream of hot gas and chemical fumigant agent leaving the fumigation apparatus outlet at or above a predetermined temperature.

The apparatus may also comprise a gas flow meter for measuring the flow rate of the gas stream in the first channel and wherein the controller is configured to control the gas regulator, pump or compressor and/or the chemical agent pump at least in part based on the flow rate measured by the gas flow meter.

The controller may implement a negative feedback loop to control the gas regulator, pump or compressor to dynamically adjust the flow rate of the gas through the first channel so as to maintain the output temperature of the mixed stream of hot gas and chemical fumigant agent at or above the predetermined temperature. The controller is configured to control the gas regulator, pump or compressor based on the temperature measured by the temperature sensor and the chemical agent pump is independent of the temperature measured by the temperature sensor and/or the flow rate of the gas stream measured by the gas flow meter. The temperature of the stream of hot gas and chemical fumigant agent leaving the fumigation apparatus outlet may be less than the temperature of the heater.

In some examples, the controller is configured to control the gas regulator, pump or compressor to flow 4,500 to 6,000 litres of gas through the first channel for every 3 litres of chemical fumigant agent pumped through the second channel by the chemical agent pump.

In some examples, the second inlet of the mixing chamber comprises a nozzle for atomizing liquid chemical agent entering the mixing chamber. The nozzle may be a hydraulic atomizing nozzle.

In some examples, the first inlet of the mixing chamber is at a first end of the mixing chamber, the second inlet of the mixing chamber is at a second end of the mixing chamber opposite to the first end so that the hot gas stream and chemical agent stream enter the mixing chamber from opposite directions so as to produce turbulence. The outlet of the mixing chamber may be positioned on a side wall joining the first end and second end of the mixing chamber so that the mixed stream of hot gas and chemical fumigant agent exits the mixing chamber through the outlet in a direction substantially perpendicular to the directions in which the hot gas stream and chemical agent stream enter the mixing chamber.

In some examples, the fumigation apparatus comprises a vaporising coil having a first end in fluid communication with the outlet of the mixing chamber and a second forming or in fluid communication with the outlet of the fumigation apparatus.

In some examples, the fumigation apparatus comprises a third channel which is to act as a purge line, the third channel being in fluid communication with the gas source and joining the second channel upstream of the mixing chamber, the third channel having a valve which when open allows the gas stream to pass through the third channel to the second channel and purge the second channel of chemical agent. The chemical agent pump may be downstream of the point at which the third channel joins the second channel so that the chemical agent pump may be purged.

In some examples, the controller, gas regulator and pump and gas flow meter are contained within a housing which is configured to provide an oxygen reduced environment. A part of the first channel passing through the housing may include a purge vent for injecting gas from the gas source into the housing so as to expel oxygen from the housing. An oxygen sensor may be provided inside the housing and wherein the controller is configured to turn off the heater in response to the oxygen sensor detecting oxygen in the housing.

In some examples, the heater is positioned above the mixing chamber. The second channel may comprise a corrosion proof material. At least the part of the first channel extending from the heater to mixing chamber may comprise a heat proof material. The vaporising coil may be heat proof and corrosion proof. The second channel and the portion of the first channel extending from the regulator to the heater may be formed of a flexible material. A flexible material of the second channel may be coated with a corrosion proof material.

In some examples the chemical fumigant agent is ethyl formate. In some examples, the non-flammable gas is an inert gas. The gas source may be external to the fumigation apparatus. The chemical agent source may be external to the fumigation apparatus.

In some examples, the fumigation apparatus comprises a second temperature sensor for measuring the temperature of the hot gas in the first channel near the heater and sending information regarding the measured temperature to the controller, and wherein the controller is configured to control the heater.

According to a second aspect of the present disclosure there is provided a fumigation apparatus comprising: a mixing chamber including a first inlet for receiving a stream of a hot gas, a second inlet for receiving a chemical fumigant agent stream and a mixing chamber outlet for outputting a mixed stream of hot gas and chemical fumigant agent; a gas regulator/pump/compressor for directing a stream of non-flammable gas along a first channel from a non-flammable gas source to the first inlet of the mixing chamber; a heater for heating the gas stream in the first channel upstream of the mixing chamber to provide a stream of hot gas to the first inlet of the mixing chamber; a chemical agent pump for directing a stream of chemical fumigant agent along a second channel from a source of chemical fumigant agent to the second inlet of the mixing chamber; a fumigation apparatus outlet in fluid communication with the mixing chamber outlet for ejecting the mixed stream of hot gas and chemical fumigant agent; wherein the first inlet of the mixing chamber is at a first end of the mixing chamber, the second inlet of the mixing chamber is at a second end of the mixing chamber opposite to the first end so that the hot gas stream and chemical agent stream enter the mixing chamber from opposite directions so as to produce turbulence.

According to a third aspect of the present disclosure there is provided a method of fumigation using the fumigation apparatus of the first aspect or the second aspect. The method comprises: flowing an inert gas through the first channel to the heater, heating the inert gas and allowing the heated inert gas to enter the mixing chamber; pumping a liquid fumigant agent through the second channel to the mixing chamber; mixing the liquid fumigant agent and the heated inert gas in the mixing chamber to form a fumigant comprising a mixture of hot gas and vaporized fumigant agent in the mixing chamber and allowing a stream of the fumigant to exit the mixing chamber and directing the fumigant from the outlet of the fumigant apparatus to an area to be fumigated.

In some examples, the inert gas is selected from the group comprising nitrogen, helium and carbon dioxide. In some examples, the liquid fumigant agent is ethyl formate.

### BRIEF DESCRIPTION OF DRAWINGS

In order for the present disclosure to be more readily understood, embodiments will now be described, by way of example, with reference to the accompanying drawings in which:

FIG. 1 is a perspective view of a fumigation apparatus according to an example of the present disclosure;

FIG. 2 is a perspective view of the fumigation apparatus of FIG. 1 in which the housing has been partially removed so that the internal components can be seen;

FIG. 3 is a side view of the fumigation apparatus of FIG. 2, showing the heater and mixing chamber;

FIG. 4 is a schematic view of the components of a fumigation apparatus according to an example of the present disclosure;

FIG. 5 is a flow diagram showing a method of controlling the output temperature by the controller of a fumigation apparatus according to an example of the present disclosure;

FIG. 6 is a further flow diagram showing a method of controlling the output temperature by the controller of a fumigation apparatus according to an example of the present disclosure;

FIG. 7 is a schematic diagram illustrating the operation of the controller to control the output fumigant temperature according to an example of the present disclosure; and

FIG. 8 is a schematic diagram illustrating a control loop for controlling the heater according to an example of the present disclosure.

### DESCRIPTION OF EMBODIMENTS

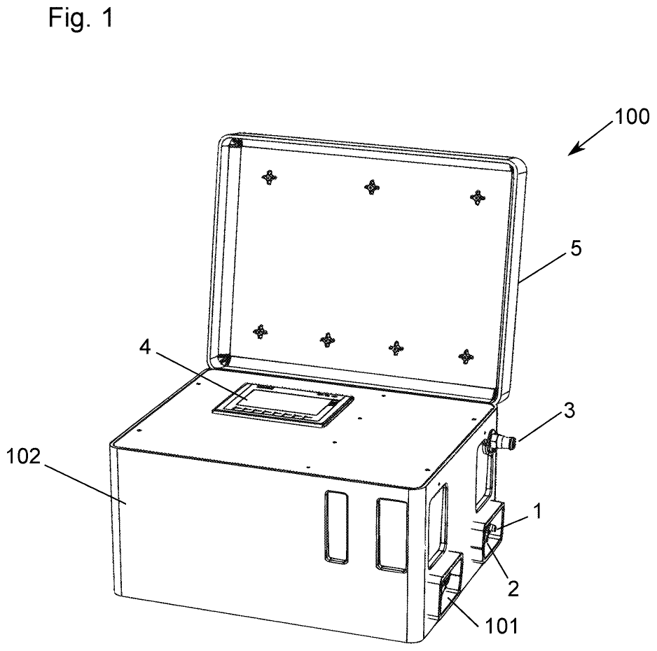

Referring initially to FIGS. 1 to 4, there is shown an example of a fumigation apparatus 100, which is used to vaporise a chemical fumigant agent, typically a liquid chemical agent, for application as a fumigant. A fumigant is a gaseous substance used to kill insects, nematodes, and other animals or plants that damage stored foods or seeds. A chemical fumigant agent is a chemical agent which may be vaporised to form a fumigant.

The fumigation apparatus 100 has particular utility to vaporise chemical agents having properties, such as flammability, which would otherwise render the chemical agent unsuitable or undesirable for use as a fumigant. However, the vaporising apparatus 100 may be used to vaporise any chemical agent which is desired to be used as a fumigant, including but not limited to, ethyl formate, methyl bromide, 1,3-dichloropropene, chloropicrin and propylene oxide. The fumigation apparatus vaporises the chemical agent by mixing a stream of hot gas with a stream of liquid chemical agent in order to vaporise the chemical agent. As certain chemical agents, such as ethyl formate, are highly flammable, the apparatus uses a non-flammable gas to heat the chemical agent. The non-flammable gas may, for example, be an inert gas such as, but not limited to nitrogen, helium or carbon dioxide.

It is desirable that the temperature of the fumigant, which comprises a mixture of hot gas and vaporised chemical agent, is kept at or above the boiling temperature of the chemical agent as it leaves the device. Otherwise the chemical agent may condense prematurely which may lead to an incomplete or ineffective fumigation. As a stream of hot gas is mixed with the stream of chemical agent, the temperature of the mixture is determined in part by the temperature of the hot gas stream and the flow rate of the hot gas stream. The flow rate of the hot gas stream is particularly significant as the higher the gas flow rate, the higher the temperature of the fumigant ejected from the device. Accordingly, a first aspect of the present disclosure proposes measuring the temperature of the fumigant leaving the fumigation apparatus and dynamically controlling the flow rate of the gas stream based on the measured temperature so as to maintain the stream of fumigant leaving the apparatus at or above a predetermined temperature.

In some previous designs of fumigation apparatus it was found that the mixing and vaporisation of the chemical agent by the hot gas was incomplete, which could lead to sub-optimum fumigation. Accordingly, a second aspect of the present disclosure proposes a mixing chamber in which a stream of hot gas enters through an inlet at a first end of the mixing chamber and the stream of chemical agent enters through an inlet at a second end of the mixing chamber opposite the first end. As the hot gas stream and chemical agent stream enter into the mixing chamber in opposing directions, this promotes turbulence and more complete mixing and vaporisation of the chemical agent.

In some examples, the components of the fumigation apparatus may be retained or otherwise housed in a housing 102. The housing 102 may comprising a frame and cover. An example is shown in FIG. 1. The housing 102 may comprise a polymer case. Desirably, the polymer case may be portable, light and resistant to water, crushing and dust. For instance, the case may be a pelican™ style case. The case may be formed of copolymer polypropylene using an open-cell core and solid-wall construction.

The fumigation apparatus 100 may be portable. For instance the fumigation apparatus 100 may be presented as a substantially compact and transportable unit.

Portability permits the apparatus 100 to be readily moved from one treatment site to another by a single operator. The portable nature and compactness of the fumigation apparatus 100 enables use in small areas such as small grain silos, as well as in larger areas such as warehouses, buildings and ship holds.

Referring to FIG. 1, the fumigation apparatus 100 may comprise a first inlet 1 for receiving a stream of non-flammable gas, a second inlet 2 for receiving a stream of liquid chemical agent and an outlet 3 for ejecting a fumigant comprising a mixture of hot gas and vaporised chemical agent. In the example shown in FIG. 1, the first inlet 1 for non-flammable gas is next to the second inlet 2 for the liquid chemical agent. The fumigation apparatus may also include a control panel 4, which may take the form of a display and be connected to a controller for controlling operation of the fumigation apparatus. For example, the control panel 4 may be used to start and stop the flow of chemical agent and non-flammable gas into the apparatus and to display and/or set temperatures and flow rates. The casing may comprise a lid 5 which may be hinged. The fumigation apparatus may have a power inlet 101 for receiving electrical power.

The first inlet 1 may be fluidly connected to an external source of non-flammable gas 11, such as a gas cylinder or gas generator, by use of a flexible tube or hose. The second inlet 2 may be fluidly connected to an external source of chemical agent 13, such as a container of liquid chemical agent, by use of a flexible tube or hose.

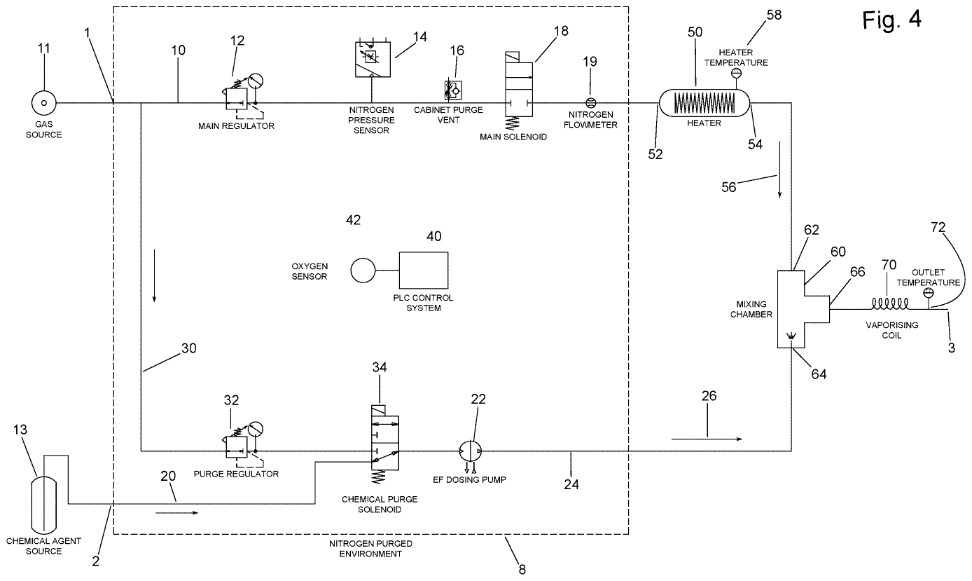

Referring to FIG. 4, the fumigation apparatus 100 comprises a first channel 10 leading from the first inlet 1 of the apparatus to a mixing chamber 60 and a second channel 20 leading from the second inlet 2 of the apparatus to the mixing chamber 60. In use, the mixing chamber 60 is used for mixing a heated stream of the non-flammable gas with a liquid stream of the chemical fumigant agent and outputs a fumigant comprising a mixed stream of hot gas and vaporized chemical fumigant agent from an outlet 66 of the mixing chamber.

The fumigation apparatus comprises a gas regulator 12 for directing a stream of the non-flammable gas along the first channel 10 from a non-flammable gas source 11 to the first inlet 62 of a mixing chamber 60. In some examples there may be a pump or compressor instead of a gas regulator, but a gas regulator is cheaper and also more easily controlled by a controller 40 of the apparatus. In most cases, even if there is a pump or compressor (either internal or external to the apparatus) for causing flow of gas through the first channel 10, there will still be a gas regulator so as to better control the pressure and flow of gas in the first channel. The gas regulator, pump or compressor is controlled by a controller 40.

The apparatus 100 further comprises a chemical agent pump 22 for directing a stream of chemical fumigant agent along the second channel 20 from a source of the chemical fumigant agent 13 to the second inlet 64 of a mixing chamber 64. The apparatus also comprises a heater 50 for heating the stream of non-flammable gas in the first channel 10 to provide a stream of hot gas to the first inlet 62 of the mixing chamber 60.

As mentioned above, the mixing chamber 60 includes a first inlet 62 (‘hot gas inlet’) for receiving a stream of a hot gas, a second inlet 64 (‘chemical agent inlet’) for receiving a stream of chemical fumigant agent and a mixing chamber outlet 66 for outputting a mixed stream of hot gas and chemical fumigant agent. The fumigation apparatus outlet 3 is in fluid communication with the mixing chamber outlet 66 and in use ejects the mixed stream of hot gas and chemical fumigant agent (‘the fumigant’) from the apparatus. The fumigation apparatus outlet 3 thus directs the fumigant into the surrounding atmosphere. The outlet 3 may have an aperture of sufficient size to maintain adequate pressure to force chemical agent/gas mixture outwardly, towards and into the area to be treated and minimize condensation of chemical agent.

An insulated delivery tube, such as a hose (not shown) may be connected to the fumigation apparatus outlet 3 so as to assist directing the fumigant to the area to be fumigated. The delivery tube should be of sufficient length to deliver the chemical agent/gas to the treatment area but also sufficiently short and of appropriately sized diameter to avoid any significant cooling and condensation of vapour as it travels from the outlet 3 to the treatment area.

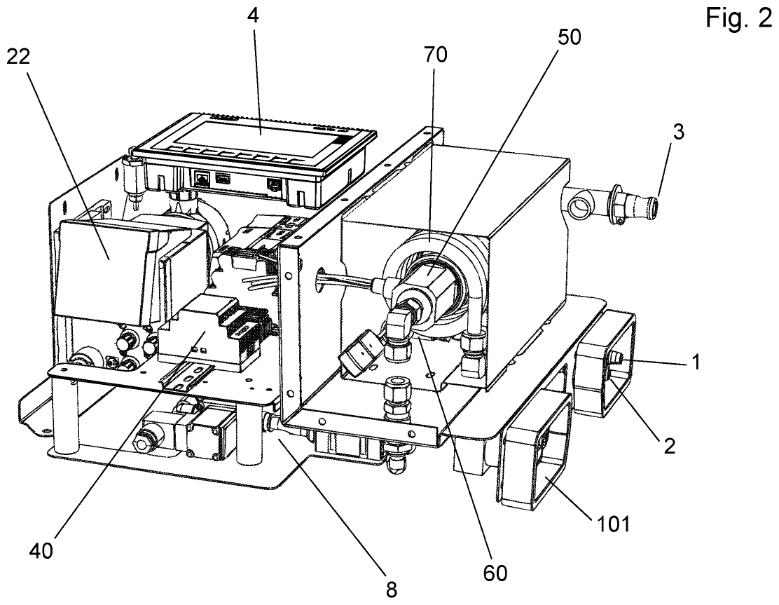

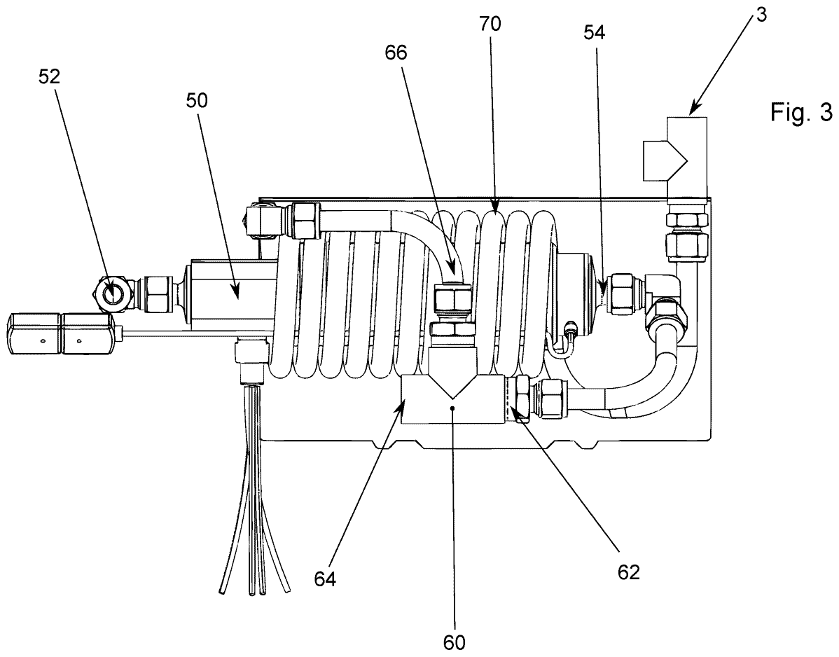

In some examples there may be a vaporising coil 70 between the outlet 66 of the mixing chamber 60 and the fumigation apparatus outlet 3. The vaporising coil is a hollow coiled tube. The vaporising coil may have a first end in fluid communication with the outlet 66 of the mixing chamber and a second end forming or in fluid communication with the outlet 3 of the fumigation apparatus. The mixing chamber 60 may be relatively small, for example the size of a cigarette box such as 80 to 12 cubic centimeters. The vaporising coil may be relatively long, for example between 2 to 6 meters in length. The diameter of the vaporising coil may, for example be between 8 mm and 20 mm. In one example the vaporising coil is 3.5m in length and 12 mm in diameter. The vaporising coil 70 allows the chemical fumigant agent to fully vaporize and mix with the stream of hot gas before being ejected from the fumigation apparatus. As the vaporising coil 70 is in the shape of a coil it is relatively compact, despite its length, which enables it to be fitted inside the housing of the fumigation apparatus as best seen in FIGS. 2 and 3. For instance, in one example, although the coil is 3.5m in length it may be fit into a space of 26 cm in length from end to end.

The apparatus may include a temperature sensor 72 for measuring a temperature of the mixed stream of gas and chemical fumigant agent leaving the fumigation apparatus outlet 3. The temperature sensor 72 may be located at or proximate the outlet 3. The apparatus comprises a controller 40 for controlling the gas regulator, pump or compressor 12 and/or the chemical agent pump based on the temperature measured by the temperature sensor 72, so as to maintain the stream of hot gas and chemical fumigant agent leaving the fumigation apparatus outlet at or above a predetermined temperature. The predetermined temperature may be equal to or higher than the boiling point of the chemical fumigant agent which is to be used. In the case of ethyl formate the predetermined temperature is at least 54 degrees Celsius. In some examples, the predetermined temperature may be greater, e.g. at least 5 degrees, at least 10 degrees or at least 15 degrees Celsius greater than the boiling point of the chemical fumigant agent. This allows for some cooling as the mixture of hot gas and vaporized chemical agent contacts the surrounding air when leaving the fumigation apparatus. This contact with the surrounding air could otherwise cause the fumigant agent to condense on leaving the apparatus, especially in winter. In some examples, the predetermined temperature is 60 degrees Celsius or greater, in some examples 65 degrees Celsius or greater, in other examples 70 degrees Celsius or greater.

The controller 40 may be an electronic device, such as a processor, microprocessor, programmable logic controller, field programmable gate array, application specific integrated chip etc. The controller may comprise a processor and machine readable storage medium, such as a read only memory, random access memory or solid state memory storing instructions which executed by the processor to perform methods of control as described herein.

The controller may be configured to receive the temperature of the output fumigant from the temperature sensor 72 and to automatically and control the gas regulator, pump or compressor 12 dynamically to adjust the flow rate of gas in the first channel 10 to achieve the desired output temperature. The desired output temperature may be referred to as the predetermined output temperature. As mentioned above, the predetermined output temperature may be equal to or higher than the boiling point of the chemical fumigant agent so that the chemical fumigant agent remains largely vaporized and does not condense immediately on leaving the apparatus.

In some examples, the fumigation apparatus may further comprises a gas flow meter 19 for measuring the flow rate of the gas stream in the first channel 10 and the controller 40 may be configured to control the gas regulator, pump or compressor 12 and/or the chemical agent pump 22 at least in part based on the flow rate measured by the gas flow meter 19. The gas flow meter may be positioned in the first channel 10 upstream of the heater 50, so the flow of the cold or non-heated gas is measured prior to being heated.

In some examples, the controller 40 is configured to use a negative feedback loop to control the gas regulator 12 to dynamically adjust the flow rate of the gas through the first channel 10 so as to maintain the temperature of the mixed stream of hot gas and chemical fumigant agent at the outlet 3 of the fumigation apparatus at or above the predetermined temperature. In some implementations, the controller 40 may control the flow rate via a gas pump or gas compressor instead of a gas regulator.

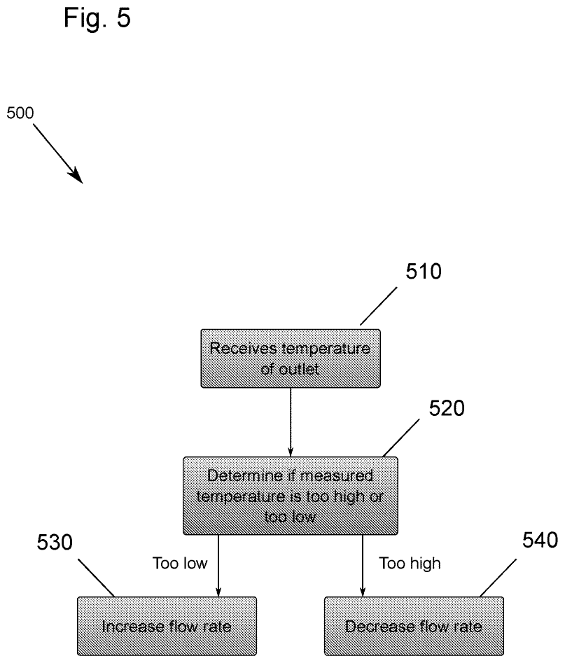

FIG. 5 is a flow diagram showing an example control method 500 of controller which uses a negative feedback loop. At block 510 the controller 40 receives the temperature of the fumigant leaving the outlet 3 of the apparatus from the temperature sensor 72. At block 520 the controller determines whether the measured temperature is too low or too high compared to the desired target temperature (‘the predetermined temperature’). If the measured temperature is too low then at block 530 the controller 40 increases the flow rate of gas in the first channel 10. If the measured temperature is too high then at block 540 the controller decreases the flow rate of gas in the first channel 10.

The flow rate of the hot gas has a large impact on the temperature of the fumigant output from the apparatus, as the faster the flow the greater the transfer of heat to outlet. If the flow rate of hot gas is too slow then the outlet temperature will drop below the predetermined temperature and the chemical fumigant agent will not fully vaporize or may condense in the apparatus or on contact with the outside air leading to ineffective fumigation. Due to the high latent heat of vaporization, gas passing through ethyl formate tends to cool down rapidly and in some cases may even freeze if the gas temperature or flow rate is too low. On the other hand if the flow rate is too high, this wastes the gas (which has a cost as inert gas is not free), may cause overheating which could damage the apparatus and may even cause the concentration of chemical fumigant agent to drop below an effective fumigation level. Accordingly, the controller is configured to automatically control the flow rate of the gas and dynamically adjust the apparatus to achieve the desired flow rate when needed.

In other examples the controller may adjust the temperature of the heater and/or the rate at which the chemical agent is pumped, as well as or instead of adjusting the flow rate of the gas stream. However, in general the rate at which the chemical agent is pumped will be set by the requirements of the fumigation. Typically a fumigation will be required to be completed in a set time and require a set volume of chemical fumigant agent (e.g. ethyl formate). The volume of fumigant chemical agent needed for a particular fumigation may be calculated based on the type of fumigant agent and volume of space to be fumigated. Increasing the volume of fumigant agent may exceed toxicity limits and would be expensive, as fumigant agent is more expensive than inert gas. Decreasing the rate of fumigant agent would increase the time for the fumigation which is undesirable as fumigation usually needs to be completed within a set time period due to commercial considerations. In a similar vein, the heater is usually operated at maximum temperature so as to maximize the flow rates at which vaporization can take place and reduce the time taken to vaporize the agent and deliver the fumigant. However, increasing the temperature of the heater too far may cause damage to the components of the apparatus. For these reasons, it is advantageous in certain implementations to control the output temperature of the fumigant by adjusting the gas flow rate rather than the heater temperature or chemical agent pump flow rate.

Accordingly, in some examples, the controller 40 may control the chemical agent pump 22 and/or the heater independently of the temperature measured by the temperature sensor 72 and the flow rate of the gas stream measured by the gas flow meter 19. Thus in some implementations the rate of the chemical agent pump 22 may be independent of the temperature of the output fumigant and the flow rate of the gas in the first channel 10.

The controller 40 may change the flow rate of gas through the first channel by adjusting the pressure of the main gas regulator 12. Increasing the pressure increases the flow rate, while decreasing the pressure decreases the flow rate. The flow rate at a given pressure will depend on various factors including the external environment into which the fumigant is ejected, e.g. there will be back pressure from the external environment depending on the extent to which the container or area being fumigated is sealed, whether there are any leaks in the container, the temperature and other conditions. As well as varying from location to location, the flow rate achieved at given pressure may vary during the fumigation process, as the degree of back pressure changes as the fumigated area fills with fumigant and if a container vent is blown off during the fumigation or other events. For this reason, the necessary pressure will depend upon the environmental conditions. Therefore, simply using the same pressure for all fumigations or having the user set the pressure and retaining a fixed pressure throughout a fumigation may not work well. Accordingly, the controller may employ a double control loop, with in an outer loop targeting a desired output temperature for the fumigant and an inner loop targeting a flow rate which will achieve the desired output temperature. In this way the apparatus is able to account for differences between different fumigation environments and dynamic changes in conditions.

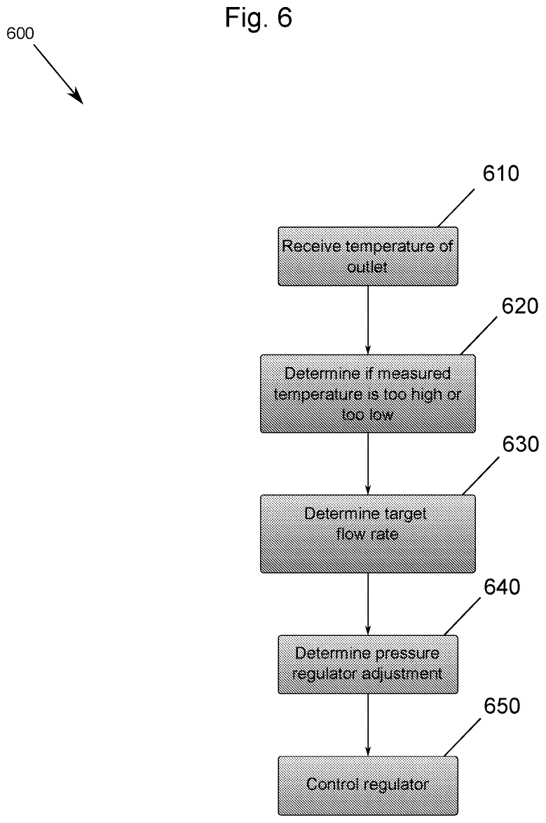

FIG. 6 is a flow diagram of a control method 600 implemented by the controller 40 according to one example which employs a double control loop. At block 610 the controller 40 receives the temperature of the fumigant leaving the outlet 3 of the apparatus from the temperature sensor 72. At block 620 the controller determines whether the measured temperature is too low or too high compared to the desired target temperature (‘the predetermined temperature’). If the measured temperature is too low then at block 630 the controller 40 determines a target flow rate or change in flow rate which will deliver the desired target temperature for the output fumigant. At block 640 the controller determines an adjustment to a control parameter of the gas regulator, pump or compressor which will deliver the target flow rate or change in flow rate determined at block 630. At block 650 the controller controls the gas regulator, pump or compressor according to the adjustment to the control parameter determined in block 640. Thus it will be appreciated that in FIG. 6, blocks 610 to 630 act as an outer control loop, while blocks 640 to 650 act as an inner control loop.

The controller 40 may be a PID controller. In some examples the controller may use the desired output temperature of the fumigant as a set point and the measured output temperature as a process value. The controlled variable may be the pressure of the regulator. In some examples a first control loop may target an output temperature and may output a desired flow rate as the set point of a second control loop and the second control loop may measure the flow rate as the process variable and control the pressure of the regulator as the control variable.

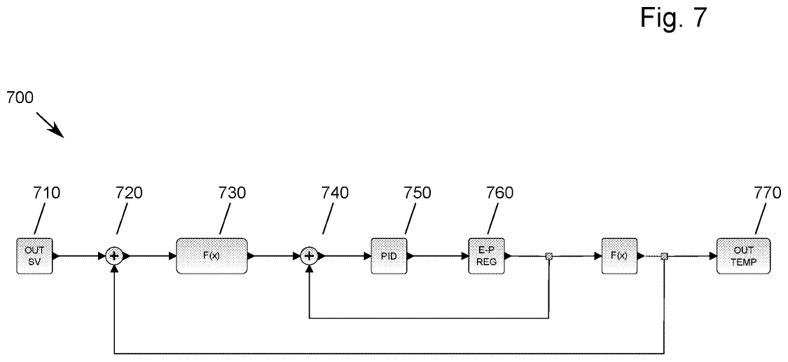

FIG. 7 shows one example of a configuration for a PID controller 700 according to an example of the present disclosure. The controller takes a target temperature 710 for the fumigant as a set point. A comparator 720 compares the target temperature to the actual temperature 770 at the outlet 3 measured by temperature sensor 72. The comparator 720 outputs the result of this comparison to a stepped function F(x) 730 which maps the comparator output (a difference in temperature) to a target flow rate. The stepped function F(x) 730 outputs the target flow rate to a second comparator 740 which compares the target flow rate to the actual flow rate of gas in the first channel 10 as measured by the flowmeter 19. The second comparator 740 outputs the difference between the target and measured flow rate as input to a PID module 750. The PID module 750 determines an adjustment to a control parameter of the gas regulator 760 in order to meet the target flow rate and controls the gas regulator accordingly. Through the fluid dynamics of the fumigation apparatus—notionally indicated by F(x)—this will result in eventually reaching the target output temperature. In this way the controller dynamically adjusts the flow rate of the hot gas stream to maintain the temperature of the fumigant exiting the apparatus at the desired level.

The gas source 11 may be a source of an inert gas. In some examples, the gas is one or more of nitrogen, carbon dioxide or helium. The gas source can be provided in a container or tank suitable for storing compressed gas, such as a cylinder, such a container having a volume that provides sufficient amount of gas for at least one treatment application of chemical agent as a fumigant. In other examples, the gas source 11 may be a gas generator, able to generate sufficient quantity of inert gas as necessary by extracting it from the atmosphere. Non-limiting examples are pressure swing adsorption (PSA) or membrane separation (MS) nitrogen generators. In one embodiment, the gas source is a nitrogen generator, capable of producing high quality (>99%) nitrogen gas. The nitrogen generator provides dried, filtered and heated air though a bank of specially designed filtering membranes. These membranes separate the nitrogen from CO₂ and O₂ exhaust gas and pass the nitrogen to a delivery pipe or other suitable conduit, for delivery to an inlet of the regulator 12.

The second inlet 62 of the mixing chamber may comprise a nozzle for atomizing the liquid chemical agent prior to or as the liquid chemical agent enters the mixing chamber. The nozzle may for example be flush with a wall of the mixing chamber or may extend a short length into the mixing chamber. By atomizing the liquid chemical agent, the nozzle promotes more rapid vaporization of the chemical agent when it contacts the hot gas stream in the mixing chamber. In some examples, the nozzle is a hydraulic atomizing nozzle. A hydraulic atomizing nozzle is a nozzle which receives a stream of liquid and atomizes the liquid without mixing the liquid with a separate stream of gas. A hydraulic atomizing nozzle may be contrasted to an air or gas atomizing nozzle which mixes a stream of liquid with gas to achieve atomization. The use of a hydraulic atomizing nozzle may slow down the vaporization in the mixing chamber, compared to use of an air or gas atomizing nozzle, which may help to avoid overheating or too rapid heating of the apparatus.

In some examples, for instance as shown in FIG. 4, the mixing chamber 60 is shaped such that the first inlet 62 of the mixing chamber is at a first end of the mixing chamber, the second inlet 64 of the mixing chamber is at a second end of the mixing chamber opposite to the first end so that the hot gas stream 56 and chemical agent stream 26 enter the mixing chamber from opposite directions. This helps to produce turbulence which enhances mixing of the chemical fumigant agent with hot gas, promotes vaporization of the chemical fumigant agent and helps to ensure more uniform distribution of the fumigant agent within the fumigant agent/gas mix. In some examples, the outlet 66 of the mixing chamber is positioned on a side wall joining the first end and second end of the mixing chamber so that the mixed stream of hot gas and chemical fumigant agent exits the mixing chamber through the outlet 66 in a direction substantially perpendicular to the directions in which the hot gas stream 56 and chemical agent stream 64 enter the mixing chamber.

As mentioned above, the gas regulator 12 may be in fluid communication with the gas source 11 via inlet 1. The gas regulator 12 controls pressure of the gas in the section of the first channel 10 before the heater 50. The pressure of the gas regulator may be controlled by the controller in order to deliver a desired flow rate of gas in the first channel and/or temperature of output fumigant from the apparatus as described above. In some examples, the pressure may be 2-3 bar. In some examples, the flow rate of the gas in the first channel, as measured by the flow meter 19, may be from 300 to 400 litres/minute. In some implementations, flow rates much higher than this may risk overheating the apparatus and/or causing damage to the internal components.

The gas regulator 12 may be in fluid communication with the heater 50. The gas regulator 12 may enable the stream of gas to be directed from the gas regulator 12 along the first channel 10 to the heater 50. The heater 50 may be an inline air heater wherein gas enters through a heater inlet 52 at a first end and heated gas exits through a heater outlet 54 at a second end. The heater 50 may be designed for substantial gas flow and rapid heating of gas introduced into the heater 50. The heater 50 may be capable of heating gas introduced into the heater 50 to significant temperatures whilst maintaining substantially ambient temperature on an exterior of the heater 50. The heater 50 may be powered from a power source (not shown), such as a single phase power source.

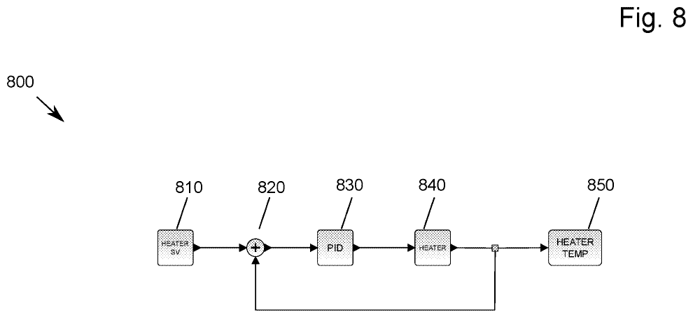

The fumigation apparatus may comprise a second temperature sensor 56 for measuring the temperature of the hot gas in the first channel 10 near the heater 50 and sending information regarding the measured temperature to the controller 40. The controller 40 may dynamically adjust the temperature of the heater 50 using a PID loop which targets a specified temperature. An example configuration of a PID control loop 800 for the heater is shown in FIG. 8. The desired heater temperature 810 is used as a set point which is input to a comparator 820. The comparator compares the desired temperature 810 with the actual temperature 850 measured by the second temperature sensor 56. The comparator 820 outputs the difference to a PID module 830 which determines an appropriate adjustment to a control parameter of the heater 840 (such as input electrical current or voltage) and controls the heater 840 accordingly to achieve the desired heater temperature. As mentioned above, the desired temperature of the heater may be fixed throughout the process and set at a level which maximizes throughput without exceeding an upper limit which may damage components of the fumigation apparatus.

The controller 40 may control both the on/off function of the heater 20 as well as managing temperature. In some examples, the heater 20 is programmed to heat to a temperature of about 180° C. to 500° C. In some examples from about 240° C. to about 320° C., or up to about 500° C. Higher temperatures of heater allow higher flow rates of gas, while still heating the gas to the sufficient temperatures. The temperature of the heater may be kept at a constant level throughout the fumigation. In many cases, the apparatus may be run with the heater at or near its maximum temperature so as to maximise flow rates and reduce time taken to vaporise the chemical agent and apply the fumigant. The temperature of the heater should be selected to be below a level which will cause damage to the internal components of the apparatus, such as the pipes or tubes forming the first channel between the heater and the mixing chamber. For this reason, in some examples, the temperature of the gas leaving the heater may be kept to 320° C. or less.

The higher the boiling point of the chemical agent, the more energy that is required to vaporise the chemical agent. Ethyl formate has the highest boiling point of the most commonly used commercially available chemical agents used in fumigation. The apparatus 100 can therefore be used to vaporise other chemical agents with lower boiling points such as, but not limited to, methyl bromide and propylene oxide. The apparatus 100 can be used to vaporise a variety of chemical agents, including flammable and non-flammable chemical agents, by appropriately adjusting and controlling the temperature of the heater 50 in use.

Gas enters the heater 50 at or adjacent the first end 52, may be heated to the desired temperature inside the heater 50 and exits the opposite end through heater outlet 54. The temperature of the heater 50 may be much greater than the temperature of the fumigant leaving the fumigation apparatus due to cooling as the gas passes through the first channel 10 from the outlet 54 of the heater to the inlet 62 of the mixing chamber 60 and because of cooling due to latent heat energy taken to vaporize the liquid chemical agent in the mixing chamber 60 and vaporization coil 70. Accordingly, the temperature of the stream of hot gas and chemical fumigant agent leaving the mixing chamber outlet 66 and leaving the fumigation apparatus outlet 3 may be less than the temperature of the heater 50. In some examples, the heater may heat the gas to 300-400° C. and the temperature of the mix of hot gas and vaporised chemical agent leaving the fumigation apparatus outlet may be 54-70° C.

The chemical agent pump 22 may be placed in fluid communication with a source of chemical agent 13. The source of chemical agent 13 may be external to and separate from the apparatus 100, enabling the apparatus 100 to draw, channel and utilise chemical agent from any source or any sized vessel, providing a substantially non-limiting source of chemical agent to the apparatus 100. This provides a significant advantage over prior art vaporising devices, in which volume of chemical agent and hence extent of application of the vaporising device is limited by the volume of a vessel, canister or other such chamber that forms part of the device itself. Maintaining the source of chemical agent separate from the apparatus 100 also provides safety advantages whereby little chemical agent remains in the apparatus 100 after use, mitigating toxicity and/or flammability risk.

In some examples the liquid chemical agent may be pumped at a rate of 15-17 litres/hour. In some examples around 15.8 litres/hour. In some examples the rate may be set so that the delivery of fumigant to the area to be fumigated can completed within 10-15 minutes. In some examples the rate of pumping by the chemical agent pump may be set so that 3 litres of liquid chemical agent can be vaporised and delivered as fumigant within 10-15 minutes, in some examples within about 14 minutes. The ratio of hot gas to vaporised chemical agent in the fumigant output from the mixing chamber and fumigation apparatus outlet will depend on the respective flow rates of the gas and the liquid chemical agent. As mentioned above, the flow rate of the gas is used primarily to control the output temperature and maintain the output temperature above a certain predetermined temperature. However, the concentration of fumigant in the output mixture should not exceed safety levels for human operation and in the case of a flammable chemical agent should be kept below the lower explosive limit (LEL). The lower explosive limit for ethyl formate is about 2.8% volume of vaporised ethyl formate to volume of non-flammable gas (e.g. nitrogen) or 92 g/m³ of ethyl formate. In some examples, it was found that for every 3 litres of liquid ethyl formate pumped to the mixing chamber, 4500-6000 litres of non-flammable gas (as measured by the flow meter) was sent to the mixing chamber.

Some known fumigation devices require an operator to measure and introduce a fixed amount of chemical agent into a vessel of the device prior to each use, requiring handling of the chemical agent and increasing risk of exposure to a potentially toxic substance. This risk is reduced by the present apparatus 100, as the operator is not required to measure out and introduce a fixed amount of chemical agent. These known fumigation devices typically conduct heating of the chemical agent in the vessel. If the vessel is not permitted to adequately cool in between applications of chemical agent, introduction of chemical agent into the vessel will cause the agent to evaporate on contact with hot elements in the vessel. Thus, once the device is depleted of the fixed amount of chemical agent, it must be stopped and cooled before it can be filled again. The present apparatus 100 avoids the need to provide a cooling period between respective applications of chemical agent and thereby enables enhanced operational efficiency.

As shown in FIG. 2, the heater 50 may be positioned above the mixing chamber 60 so as to prevent any condensed chemical agent from the mixing chamber 60 dripping into the heater 50, which might risk causing a fire due to the flammable nature of certain chemical agents.

The first channel 10 may comprise one or tubes of flexible material. The first channel may further comprise one or more pipes of heat proof material, such as a metal, proximate the heater 50 and leading from the outlet of the heater 54 to the first inlet of the mixing chamber 62. The second channel may comprise one or more tubes of flexible material joining the inlet 2 to the chemical agent pump 22 and the second inlet 64 of the mixing chamber. The second channel may comprise or be coated with a corrosion proof material. For instance, material capable of transporting chemical agents such as organic solvents without significant degradation, such as silicone, polyethylene, fluorinated ethylene-propylene or teflon. The mixing chamber 60 may be formed of heat proof and corrosion proof material, such as but not limited to stainless steel.

The fumigation apparatus may have a third channel 30 which is to act as a purge line. The third channel 30 is in fluid communication with the gas source 11 and joins the second channel 20 upstream of the mixing chamber 60. As shown in FIG. 4, the third channel 30 may have a valve 34, such as a solenoid valve, which when open allows the gas stream to pass through the third channel 30 to the second channel 20 and thus purge the second channel 20 of chemical agent. This helps to maintain the longevity of the fumigation apparatus, as even where the second channel is formed of or coated with corrosion proof materials, it has been found that exposure over an extended period of time can cause degradation and failure, especially if the channel is not cleaned and residue of the chemical agent is left in the second channel. Purging may also be used where the fumigation device is to be subsequently used with a different fumigant, so as to prevent undesired chemical reactions in the apparatus.

The third channel 30 may be connected to the first channel 10 via a purge regulator 32. The purge regulator and/or purge valve 34 may act to prevent back flow of chemical agent into the first channel. In other examples a separate one way valve may be provided for this purpose. In the illustrated example, the purge valve 34 is a two way valve which in a first state connects the purge regulator 32 and/or first channel 10 to the second channel downstream of the purge valve 34 and in a second state connects the chemical agent source and/or second channel upstream of the purge valve 34 to the second channel downstream of the purge valve which leads towards the second inlet 64 of the mixing chamber.

In some examples, as illustrated in FIG. 4, the chemical agent pump 22 is located downstream of the point at which the third channel 30 joins the second channel 20 (i.e. downstream of the purge valve 34) so that the chemical agent pump may be purged. This helps to prevent degradation of the pump, which has surprisingly been found to occur even in supposedly corrosion proof pumps, due to the corrosive nature of certain chemical fumigant agents.

As shown in FIG. 4, the controller 40, gas regulator 12, pump 22 and gas flow meter 19 may be contained within a housing 102 which is configured to provide an oxygen reduced environment 8. As shown, other components, especially electronically controlled components, may also be contained within the oxygen reduced environment so as to reduce risk of fire. A part of the first channel 10 passing through the housing 102 may include a purge vent 16 for injecting gas from the gas source 11 into the housing so as to expel oxygen from the housing. In this way an oxygen reduced environment may be achieved. An oxygen sensor 42 may be provided inside the housing 102 and the controller 40 may be configured to turn off the heater 50 in response to the oxygen sensor detecting oxygen in the housing. As the same source of gas 11 is used to both purge the housing and supply the gas which is heated by the heater, the oxygen sensor is thus able to detect if any significant level of oxygen is present in the gas which is streamed to the heater. In response to detecting oxygen levels above a certain threshold, the controller 40 may automatically switch off the heater 50 to prevent or reduce risk of fire. The controller 40 may continue to stream gas through the channel 10 and to the heater 50 for a period of time after the heater is shut down, so as to cool the heater.

This fumigation apparatus 100 described herein has utility for surface applications, including treatment of empty containers to mitigate risk of pest infestation once a material such as a bulk commodity is introduced into the container.

A method of fumigation using the fumigation apparatus 100 as described above may comprises flowing an inert gas through the first channel 10 to the heater 50, heating the inert gas and allowing the heated inert gas to enter the mixing chamber 60; pumping a liquid fumigant agent through the second channel 20 to the mixing chamber 60; mixing the liquid fumigant agent and the heated inert gas in the mixing chamber 60 to form a fumigant comprising a mixture of hot gas and vaporized fumigant agent in the mixing chamber 60 and allowing a stream of the fumigant to exit the mixing chamber and directing the fumigant from the outlet of the fumigant apparatus to an area to be fumigated. The combined mixture of gas and chemical agent exiting the outlet 3 may be applied to a surface of the treatment area as a thin film, giving the surface a damp appearance, but which may be rapidly evaporated from the surface being treated. Surface temperature of the treated surface, raised by application of the hot gas stream, is used to complete evaporation of chemical agent.

In some examples, the inert gas may be one or more of nitrogen, helium and carbon dioxide. In some examples, the liquid fumigant agent may be ethyl formate, propylene oxide or methyl bromide. In some exmaples the liquid fumigant agent is ethyl formate.

In use, the source of chemical agent 13 and gas source 11 may be placed locally to the apparatus 100 and area requiring treatment. The gas source 11 and chemical agent source 13 are each connected to the apparatus 100 via first inlet 1 and second inlet 2 respectively. In the event the gas source is a gas generator, such as a nitrogen generator, the gas source is activated until a required gas purity is achieved. When the gas source is nitrogen, it is preferred that >99%, more preferably about >99.4% nitrogen purity is achieved.

Chemical agent may be drawn into the apparatus 100 and directed towards the second inlet 64 of the mixing chamber 60 via the second channel 20 by action of the pump 22. Gas may be channelled from the gas source 11 towards the heater 50 via first channel 10 by the gas regulator 12. The heater 50 may be operated by the controller 40 and the pressure of the gas regulator controlled by the controller as described above.

Gas is heated in the heater 50 and hot gas exits via heater outlet 54 and is directed towards the first inlet 62 of the mixing chamber 60 whereupon the hot gas stream 56 is contacted with the liquid particle stream of chemical agent entering the mixing chamber 64 via a nozzle (not shown) at the second inlet 64, thereby vaporising the liquid particles and mixing with the vaporised chemical agent particles in the mixing chamber 60 and vaporising coil 70, forming a vaporised chemical agent/gas mixture. This vaporised chemical agent/gas mixture is the fumigant that is suitable for application to a treatment area. The agent/gas mixture is directed towards and out of the outlet 3 and may be applied to the treatment area by an insulated delivery tube (not shown).

On completion of fumigation treatment to the treatment area, the apparatus 100 may be switched off or powered down, ceasing flow of gas and chemical agent. The apparatus 100 may be used in a further treatment application at any time thereafter, as required. While vaporising the chemical agent and applying the fumigant may take 10 to 40 minutes depending on the size of the shipping container, warehouse or area to be fumigated, the fumigation will typically take several hours as the fumigant is left to settle and act on the applied surfaces for a holding period of time.

If a further treatment application requires use of a different chemical agent to the chemical agent used in a prior application, the apparatus 100 may be purged with gas as described above, or flushed or cleaned with suitable liquid to remove residue of the first chemical agent. Since the chemical agent is not stored in the apparatus 100 and vaporisation of chemical agent is substantially complete in any application, little chemical agent residue remains in the apparatus 100 after use, which significantly speeds up the cleaning process.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A fumigation apparatus comprising:
a mixing chamber including a first inlet for receiving a stream of a hot gas, a second inlet for receiving a stream of chemical fumigant agent and a mixing chamber outlet for outputting a mixed stream of hot gas and chemical fumigant agent;
a gas regulator, pump or compressor for directing a stream of non-flammable gas along a first channel from a non-flammable gas source to the first inlet of the mixing chamber;
a heater for heating the stream of non-flammable gas in the first channel to provide a stream of hot gas to the first inlet of the mixing chamber;
a chemical agent pump for directing a stream of chemical fumigant agent along a second channel from a source of the chemical fumigant agent to the second inlet of the mixing chamber;
a fumigation apparatus outlet in fluid communication with the mixing chamber outlet for ejecting the mixed stream of hot gas and chemical fumigant agent;
a temperature sensor for measuring a temperature of the mixed stream of gas and chemical fumigant agent leaving the fumigation apparatus outlet; and
a controller for controlling the gas regulator, pump or compressor and/or the chemical agent pump based on the temperature measured by the temperature sensor, so as to maintain the stream of hot gas and chemical fumigant agent leaving the fumigation apparatus outlet at or above a predetermined temperature.

2. The fumigation apparatus of claim 1, further comprising a gas flow meter for measuring the flow rate of the gas stream in the first channel and wherein the controller is configured to control the gas regulator, pump or compressor and/or the chemical agent pump at least in part based on the flow rate measured by the gas flow meter.

3. The fumigation apparatus of claim 1, wherein the controller is to use a negative feedback loop to control the gas regulator, pump or compressor to dynamically adjust the flow rate of the gas through the first channel so as to maintain the output temperature of the mixed stream of hot gas and chemical fumigant agent at or above the predetermined temperature.

4. The fumigation apparatus of claim 1, wherein the controller is to control the gas regulator, pump or compressor based on the temperature measured by the temperature sensor and the chemical agent pump is independent of the temperature measured by the temperature sensor and/or the flow rate of the gas stream measured by the gas flow meter.

5. The fumigation apparatus of claim 1, wherein the predetermined temperature is at least 54 degrees Celsius.

6. (canceled)

7. The fumigation apparatus of claim 1, a wherein the controller is configured to control the gas regulator, pump or compressor to flow 4,500 to 6,000 litres of gas through the first channel for every 3 litres of chemical fumigant agent pumped through the second channel by the chemical agent pump.

8. The fumigation apparatus of claim 1, wherein the second inlet of the mixing chamber comprises a nozzle for atomizing liquid chemical agent entering the mixing chamber, the nozzle preferably being a hydraulic atomizing nozzle.

9. (canceled)

10. The fumigation apparatus of claim 1, wherein the first inlet of the mixing chamber is at a first end of the mixing chamber, the second inlet of the mixing chamber is at a second end of the mixing chamber opposite to the first end so that the hot gas stream and chemical agent stream enter the mixing chamber from opposite directions so as to produce turbulence.

11. The fumigation apparatus of claim 10, wherein the outlet of the mixing chamber is positioned on a side wall joining the first end and second end of the mixing chamber so that the mixed stream of hot gas and chemical fumigant agent exits the mixing chamber through the outlet in a direction substantially perpendicular to the directions in which the hot gas stream and chemical agent stream enter the mixing chamber.

12. The fumigation apparatus of claim 1, further comprising a vaporising coil, the vaporising coil having a first end in fluid communication with the outlet of the mixing chamber and a second end which forms the outlet of the fumigation apparatus or is in fluid communication with the outlet of the fumigation apparatus.

13. The fumigation apparatus of claim 1, having a third channel which is to act as a purge line, the third channel being in fluid communication with the gas source and joining the second channel upstream of the mixing chamber, the third channel having a valve which when open allows the gas stream to pass through the third channel to the second channel and purge the second channel of chemical agent.

14. (canceled)

15. The fumigation apparatus of claim 1, wherein the controller, gas regulator and pump and gas flow meter are contained within a housing which is configured to provide an oxygen reduced environment and wherein the housing optionally includes a purge vent.

16. (canceled)

17. The fumigation apparatus of claim 15, wherein an oxygen sensor is provided inside the housing and wherein the controller is configured to turn off the heater in response to the oxygen sensor detecting oxygen in the housing.

18. (canceled)

19. The fumigation apparatus of claim 1, wherein at least one of:
the second channel comprises a corrosion proof material,
at least the part of the first channel extending from the heater to mixing chamber comprises a heat proof material,
the vaporising coil is heat proof and corrosion proof,
the second channel and the portion of the first channel extending from the regulator to the heater is formed of a flexible material,
the flexible material of the second channel is coated with a corrosion proof material, and
the heater is positioned above the mixing chamber.

20. The fumigation apparatus of claim 1, wherein the chemical fumigant agent is ethyl formate.

21. (canceled)

22. The fumigation apparatus of claim 1, wherein at least one of the gas source and the chemical agent source is external to the fumigation apparatus.

23. (canceled)

24. The fumigation apparatus of claim 1, further comprising a second temperature sensor for measuring the temperature of the hot gas in the first channel near the heater and sending information regarding the measured temperature to the controller, and wherein the controller is configured to control the heater.

25. A fumigation apparatus comprising:
a mixing chamber including a first inlet for receiving a stream of a hot gas, a second inlet for receiving a chemical fumigant agent stream and a mixing chamber outlet for outputting a mixed stream of hot gas and chemical fumigant agent;
a gas regulator/pump/compressor for directing a stream of non-flammable gas along a first channel from a non-flammable gas source to the first inlet of the mixing chamber;
a heater for heating the gas stream in the first channel upstream of the mixing chamber to provide a stream of hot gas to the first inlet of the mixing chamber;
a chemical agent pump for directing a stream of chemical fumigant agent along a second channel from a source of chemical fumigant agent to the second inlet of the mixing chamber;
a fumigation apparatus outlet in fluid communication with the mixing chamber outlet for ejecting the mixed stream of hot gas and chemical fumigant agent;
wherein the first inlet of the mixing chamber is at a first end of the mixing chamber, the second inlet of the mixing chamber is at a second end of the mixing chamber opposite to the first end so that the hot gas stream and chemical agent stream enter the mixing chamber from opposite directions so as to produce turbulence.

26. A method of fumigation using the fumigation apparatus of claim 1, wherein the method comprises:
flowing an inert gas through the first channel to the heater, heating the inert gas and allowing the heated inert gas to enter the mixing chamber;
pumping a liquid fumigant agent through the second channel to the mixing chamber;
mixing the liquid fumigant agent and the heated inert gas in the mixing chamber to form a fumigant comprising a mixture of hot gas and vaporized fumigant agent in the mixing chamber and allowing a stream of the fumigant to exit the mixing chamber and directing the fumigant from the outlet of the fumigant apparatus to an area to be fumigated.

27. The method of claim 26, wherein the inert gas is selected from the group comprising nitrogen, helium and carbon dioxide.

28. (canceled)
